(19) United States
(12) Patent Application Publication
(10) Pub. No.: US 2026/0178900 A1
(43) Pub. Date: Jun. 25, 2026

(54) METHOD FOR PREDICTING THE PACKET ERROR PROBABILITY OF A RADIO LINK USING DEEP NEURAL NETWORKS

(71) Applicant: THALES, MEUDON (FR)

(72) Inventors: Christophe LE MARTRET, GENNEVILLIERS (FR); Xavier LETURC, GENNEVILLIERS (FR)

(21) Appl. No.: 19/124,791

(22) PCT Filed: Oct. 20, 2023
(86) PCT No.: PCT/EP2023/079383

§ 371 Date: Apr. 25, 2025

(30) Foreign Application Priority Data
Oct. 27, 2022 (FR) 2211186

(51) Int. Cl. G06N 3/08; G06N 3/045; G06N 3/084; H04L 1/00

(52) U.S. Cl. CPC G06N 3/08; G06N 3/045; G06N 3/084; H04L 1/0003; H04L 1/0026

(57) ABSTRACT

A method is provided for predicting a predicted packet error rate of a radio link (L_{R}) between a transmitter and a receiver in a wireless communication network for a plurality of modulation coding schemes (MCS), the predicting method including: a step of receiving an SNR vector; a step of determining a vector of calibration parameters on the basis of the SNR vector, the step of determining the vector of calibration parameters being carried out on the basis of an architecture of deep neural networks; a step of processing the calibration parameters by means of a differentiable mathematical function, with a view to obtaining the predicted effective signal-to-noise ratio a step of Gaussian mapping making it possible to determine the predicted packet error rate on the basis of the predicted effective signal-to-noise ratio.

### CROSS-REFERENCE TO RELATED APPLICATIONS

This application is a National Stage of International patent application PCT/EP2023/079383, filed on Oct. 20, 2023, which claims priority to foreign French patent application No. FR 2211186, filed on Oct. 27, 2022, the disclosures of which are incorporated by reference in their entirety.

### FIELD OF THE INVENTION

The present invention relates to a wireless telecommunications network and more particularly to a method for predicting the quality of the transmission of data over this telecommunications network in terms of packet error rate or effective SNR. Two applications are particularly targeted by the invention, namely resource allocation with a view to allocating the best resources to the transmitter (power, modulation coding scheme (MCS), etc.) and link abstraction with a view to simulating the telecommunications network.

### BACKGROUND

FIG. 1 shows a known method for predicting a packet error rate (PER), denoted \hat{p}, of a radio link between a transmitter and a receiver. This method comprises:
a step of receiving a vector S of signal-to-noise ratios (SNR vector) measured on the link. For example, in the case of an OFDM or frequency-hopping system (OFDM standing for orthogonal frequency-division multiplexing), the SNRs are measured or calculated (depending on the targeted application) in each of the dimensions, per carrier or on each level respectively, then the PER of the link may be deduced. In the prior art of FIG. 1, the method further comprises a step of processing said SNR vector S by means of an EESM function (EESM standing for exponential effective SINR mapping), said EESM function having two parameters that may be written as follows:

$$- {c}_{2} log \frac{1}{N} {\sum }_{i = 1}^{N} {e}^{\frac{- {S}_{i}}{{c}_{1}}}$$

with c₁ and c₂ calibration parameters, Sᵢ the ith value of the SNR vector S, and i ranging from 1 to N, with N a non-zero natural integer representing the length of the SNR vector. This EESM function is in particular disclosed in the article by I. Latif, F. Kaltenberger and R. Knopp, “Link abstraction for multi-user MIMO in LTE using interference-aware receiver”, 2012 IEEE Wireless Communications and Networking Conference (WCNC), 2012, pp. 842-846, doi: 10.1109/WCNC.2012.6214489, which will be referred to as the document Latif et al.

Processing with the EESM function makes it possible to estimate an effective SNR \hat{γ}. The predicted PER \hat{p} is then determined on the basis of a “Gaussian mapping” function, which associates a PER value with an SNR value in a Gaussian channel for a given modulation coding scheme (MCS). This mapping function is constructed on the basis of a set of N_{M} points P={(γ_{M}(i), p_{M}(i)) for i=1, . . . , N_{M}} obtained by simulating the radio link and takes the form of a look-up table (LUT), where γ_{M}(i) is the signal-to-noise ratio in the Gaussian channel and p_{M}(i) is the error rate measured for this SNR value for a given MCS. When the values of \hat{γ} do not belong to the set of points of the set P, it is necessary to carry out an interpolation to calculate the value of the PER. There are then two ways of carrying out the mapping: 1) a piecewise interpolation approach, 2) a global interpolation approach involving all the points. In case 1) it is possible for example to use a linear interpolation, i.e. if γ_{M}(i)≤γ≤γ_{M}(i+1) then \hat{p}=α\hat{γ}+b is calculated with

$$a = \frac{{p}_{M} ( i + 1 ) - {p}_{M} ( i )}{{γ}_{M} ( i + 1 ) - {γ}_{M} ( i )}$$

and b=p_{M}(i)−αγ_{M}(i). In case 2) an interpolation function gᵢₙₜₑᵣ(x) is constructed, for example via a Lagrange polynomial interpolation passing through the points of the set P. In this case, the estimated PER is given by \hat{p}=gᵢₙₜₑᵣ(\hat{γ}). The resulting function gᵢₙₜₑᵣ(x) is differentiable, which will be an assumption in the description of one particular learning mode of one embodiment of the invention.

The predicting method of FIG. 1 requires a phase of calibration of the model to determine (c₁, c₂), which calibration is carried out on the basis of a database of N_{D} pairs {(S(i), p(i)), i=1, . . . , N_{D}} obtained by simulation or measurement, p(i) being the packet error rate associated with the parameter vector S(i) of the ith element of the database. Because of a long simulation time, this database is very expensive to obtain. Lastly, the accuracy of the obtained predictions is limited.

FIG. 2 illustrates an alternative solution known in the prior art, using a deep neural network trained on a database (not shown). This deep neural network is configured to receive as input the SNR vector S and to deliver as output the predicted PER \hat{p}. Use of a neural network in a method for predicting the performance of a radio link is in particular disclosed in the publication E. Chu, J. Yoon, and B. C. Jung, “A Novel Link-to-System Mapping Technique Based on Machine Learning for 5G/IoT Wireless Networks”, Sensors 2019, 19, 1196, https://doi.org/10.3390/s19051196.

The ability of the predicting method of FIG. 2 to infer accurately is low if the deep neural network is trained on a frugal database, i.e. a database of small size (cardinality of about a few thousands) and said predicting method does not provide an improvement in terms of inference performance compared with the method not employing a neural network, described in paragraph [3].

There is therefore a need to provide a method for predicting a parameter representative of the quality of the radio link between the transmitter and the receiver that is simple and practical to implement and the inference performance of which is better than the inference performance of the aforementioned prior-art solutions in the case of a frugal database.

### SUMMARY OF THE INVENTION

The present invention aims to meet this need. More particularly, the objective of the present invention is to claim a method for predicting a predicted packet error rate of a radio link between a transmitter and a receiver in a wireless communication network for a plurality of modulation coding schemes, said predicting method comprising:
a step of receiving an SNR vector;
a step of determining a vector of calibration parameters on the basis of said SNR vector, said step of determining the vector of calibration parameters being carried out on the basis of an architecture of deep neural networks;
a step of processing said calibration parameters by means of a differentiable mathematical function, with a view to obtaining the predicted effective signal-to-noise ratio;
a step of Gaussian mapping making it possible to determine the predicted packet error rate on the basis of the predicted effective signal-to-noise ratio.

In one particular embodiment, the Gaussian mapping is performed by piecewise interpolation and said predicting method comprises:
a step of learning weights of the deep neural networks on the basis of pairs containing an SNR vector and an associated effective signal-to-noise ratio, said pairs being determined for the plurality of modulation coding schemes, said pairs being stored beforehand in a learning database, the effective signal-to-noise ratios of the pairs being determined via an inversion of the Gaussian mapping, said Gaussian mapping being obtained via simulation of a Gaussian channel for a given modulation coding scheme.

In one particular embodiment, the Gaussian mapping is performed by global interpolation and said predicting method comprises:
a step of learning weights of the deep neural networks on the basis of pairs containing an SNR vector and an associated packet error rate, said pairs being determined for the plurality of modulation coding schemes, said pairs being stored beforehand in a learning database.

The method thus makes it possible to predict an effective SNR and then to deduce therefrom the PER of a link on the basis of a vector of measured/estimated data, which here is contained in the SNR vector S, which is a characteristic of the link. Furthermore, it may be possible to take into account an invariance of the channel attenuation vectors of the radio link. The deep neural network no longer directly predicts the PER as in the prior art, but rather calibration parameters. The conventional prior-art method without neural network predicts the PER on the basis of the SNR vector through a function (for example an EESM) parameterized by one or two coefficients, which coefficients are constants regardless of the SNR vector provided as input to the device. Thus, since the two prior-art approaches have the same inputs and outputs, it is completely impossible to deduce the invention by merging the two prior-art approaches. In the invention, the calibration parameters are generated by the neural network for each SNR vector provided as input to the device. According to the inventors, what makes it possible to implement this solution is a property that has never been disclosed in the prior art. Specifically, it may be shown that it is always possible to find a set of calibration parameters that makes it possible to predict the PER without error for any SNR vector S, and hence the neural networks produce as many different calibration parameters as there are input SNRs, each with a prediction error that is zero or very low. Thus, the proposed architecture, which is based on this property, which has never been revealed in the prior art, is an undeniable source of progress. The proposed architecture allows convergence on very well trained networks, then leading to a good inference performance as a result of the generalization capabilities of neural networks when their weights are correctly trained. These calibration parameters are then intended to be applied to the mathematical function that is differentiable with respect to said parameters. This training is performed by means of a conventional neural-network training algorithm given a criterion to be optimized between the output of the predicting system and the corresponding value in the database, the mean squared error for example. Two training modes will be distinguished between below, depending on whether the Gaussian mapping function is performed by piecewise interpolation (point 1 of paragraph [3]) or by global interpolation (point 2 of paragraph [3]).

In one particular embodiment, the SNR vector is determined on the basis of a step of processing a channel attenuation vector of the radio link.

In one particular embodiment, the step of processing the channel attenuation vector comprises a processing step making it possible to take into account a number of transmit antennas, the transmitter having a plurality of antennas, and a number of receive antennas, the receiver having a plurality of antennas, with a view to obtaining a signal-to-noise-ratio vector.

In one particular embodiment, the step of processing the channel attenuation vector comprises a step of processing of invariance by permutation of the signal-to-noise-ratio vector to obtain the SNR vector.

In one particular embodiment, the processing of invariance by permutation is a sorting operation.

In one particular embodiment, the processing of invariance by permutation is a discretization operation.

In one particular embodiment, the processing of invariance by permutation is performed by other deep neural networks.

In one particular embodiment, the SNR vector is concatenated with an average signal-to-noise ratio.

In one particular embodiment, the SNR vector is concatenated with a vector encoding one 1 among M zeroes, in the case of M modulation coding schemes (MCS).

In one particular embodiment, the differentiable mathematical function (ƒ(c, S)) corresponds to the following equation:

$$f ( c , S ) = - {c}_{2} log \frac{1}{N} {\sum }_{i = 1}^{N} {e}^{\frac{- {S}_{i}}{{c}_{1}}}$$

with c₁ a first calibration parameter and c₂ a second calibration parameter, Sᵢ the ith value of the SNR vector S, and i ranging from 1 to N.

In one particular embodiment, the first calibration parameter c₁ is equal to 1 and said differentiable mathematical function (ƒ(c, S)) corresponds to the following equation:

$$f ( c , S ) = - {c}_{2} log \frac{1}{N} {\sum }_{i = 1}^{N} {e}^{- {S}_{i}} .$$

In one particular embodiment, the second calibration parameter c₂ is equal to 1 and said differentiable mathematical function (ƒ(c, S)) corresponds to the following equation:

$$f ( c , S ) = - log \frac{1}{N} {\sum }_{i = 1}^{N} {e}^{\frac{- {S}_{i}}{{c}_{1}}} .$$

### BRIEF DESCRIPTION OF THE DRAWINGS

The present invention will be better understood on reading the detailed description of embodiments which are given by way of non-limiting examples and illustrated by the appended drawings, in which:

FIG. 1 illustrates one prior-art method for predicting a PER of a radio link between a transmitter and a receiver;

FIG. 2 illustrates another prior-art method for predicting a PER of a radio link between a transmitter and a receiver using an architecture of deep neural networks;

FIG. 3 illustrates a method for predicting a PER according to a first embodiment of the invention;

FIG. 4 more particularly illustrates a learning step of the predicting method of FIG. 3 when the Gaussian mapping is performed by piecewise interpolation;

FIG. 5 more particularly illustrates a learning step of the predicting method of FIG. 3 when the Gaussian mapping is performed by global interpolation;

FIG. 6 illustrates a method for predicting a packet error rate according to a second embodiment of the invention;

FIG. 7 illustrates a method for predicting a packet error rate according to a third embodiment of the invention;

FIG. 8 details a processing step of the predicting method of FIG. 7;

FIG. 9 illustrates an operation performed by deep neural networks with a view to processing of invariance by permutation in the predicting method of FIG. 8.

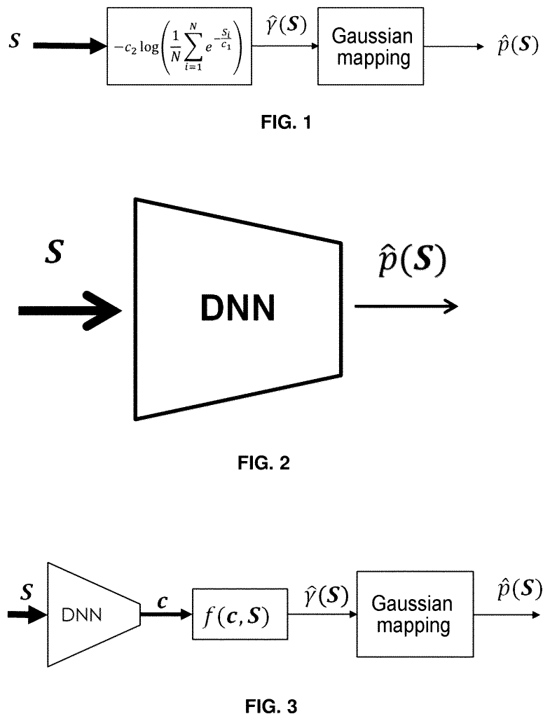

### DETAILED DESCRIPTION

In the following description, vectors have been referenced in bold with respect to scalars. In the same way, in the figures, vectors have been referred in bold and the associated lines have a larger thickness than the thickness of lines associated with scalars.

FIG. 3 illustrates a method for predicting a packet error rate p according to a first embodiment of the invention.

In this first embodiment, the predicting method comprises:
a step of receiving an SNR vector S;
a step of determining a vector c of calibration parameters on the basis of the SNR vector S using a deep neural network;
a step of processing the calibration parameters c by means of a differentiable mathematical function ƒ(c, S), with a view to obtaining the predicted effective signal-to-noise ratio \hat{γ}.

a step of determining the packet error rate \hat{p} on the basis of the predicted effective signal-to-noise ratio \hat{γ} using a Gaussian mapping function.

The SNR vector S contains discriminating parameters of the radio link. In the case of link prediction for systems that experience a plurality of SNRs during transmission of a packet (carriers in OFDM, levels in the context of frequency hopping, etc.), the input vector necessarily contains SNRs. These SNRs may be expressed in linear terms or in dB, or even generally after having undergone any predistortion. The values of the SNRs S used in the function ƒ(c, S) are not necessarily predistorted or are not necessarily predistorted in the same way as the SNRs input into the deep neural network. For example, in the EESM case, the SNR values used in the formula

$$f ( c , S ) = - {c}_{2} log \frac{1}{N} {\sum }_{i = 1}^{N} {e}^{\frac{- {S}_{i}}{{c}_{1}}}$$

are expressed in linear terms, whereas the SNRs input into the deep neural network may be expressed in dB.

FIG. 5 illustrates one particular embodiment in which information items referenced u are concatenated. These information items are, for example, an average signal-to-noise ratio S̅N̅R̅ and/or an information item regarding the modulation coding scheme in question. One possible way of informing the network of the MCS is to use a one-hot vector o, i.e. a vector encoding one 1 among M zeroes, in the case of M MCS. This makes it possible to take into account a plurality of MCS with the same architecture of neural networks, i.e. with the same weights. The learning database thus consists of the pairs (S, p) of the various MCS in question. For example, for M=3 MCS, o=[100] or o=[010] or o=[001].

It would be possible to associate other information items if necessary depending on the problem to be solved.

As a variant, it would be possible to replace the SNRs with data of CSI or CQI type (CSI standing for channel state information and CQI standing for channel quality indicator).

The step of determining the vector c of calibration parameters is carried out on the basis of a DNN architecture (DNN standing for deep neural network). By “deep neural network”, what is meant is a neural network composed of at least three layers, including two hidden layers and one output layer. The number of neurons of each layer may be different.

The weights W of the various deep neural networks are determined by a learning algorithm A on the basis of a plurality of vectors S and of the associated packet error rates stored beforehand in a learning database BD and of a Gaussian mapping. The database consists of a set of N_{D} pairs {(S(i), p(i)), i=1, . . . , N_{D}} obtained by simulation or measurement, p(i) being the packet error rate associated with the parameter vector S(i) of the ith element of the database. Depending on how the Gaussian mapping is implemented, either by piecewise interpolation or by global interpolation, two different learning schemes are applied.

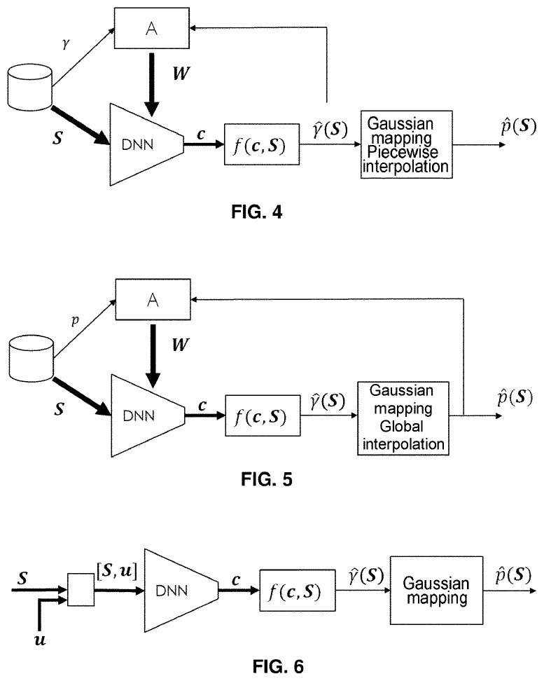

In the case of a Gaussian mapping by piecewise interpolation, the learning scheme is illustrated in FIG. 4. Since the Gaussian mapping function with piecewise interpolation is not differentiable, it is not possible for application of the learning algorithms of neural networks to use the value of the PER output from the Gaussian mapping as criterion to optimize. In order to remedy this problem, the learning is carried out considering the effective SNR as criterion to be optimized. It is necessary to create a new learning database BD consisting of N_{D} pairs {(S(i), γ(S(i)), i=1, . . . , N_{D}} where the γ(S(i)) are deduced from the p(i) by inverting the Gaussian mapping, for example via linear interpolation.

The learning algorithm A is configured to receive a plurality of predicted effective signal-to-noise ratios \hat{γ} delivered as output from the predicting method.

The learning algorithm A will then modify the weights of the various deep neural networks so as to satisfy the following equation:

$$min {\sum }_{i ∈ {N}_{D}} {\vert \hat{γ} ( S ( i ) ) - γ ( S ( i ) ) \vert}^{2}$$

The weights of the deep neural networks are saved.

In the case of a Gaussian mapping by global interpolation, the learning scheme is illustrated in FIG. 5. Since the Gaussian mapping is performed by a differentiable function, application of the learning algorithms of neural networks uses the value of the PER output from the Gaussian mapping as criterion to optimize.

The learning algorithm A is configured to receive a plurality of predicted packet error rates \hat{p} delivered as output from the predicting method.

The learning algorithm A will then modify the weights of the various deep neural networks so as to satisfy the following equation:

$$min {\sum }_{i ∈ {N}_{D}} {\vert \hat{p} ( S ( i ) ) - p ( i ) \vert}^{2}$$

The weights of the deep neural networks are saved.

The vector c of calibration parameters is processed by a differentiable mathematical function ƒ(c, S) to obtain the predicted effective signal-to-noise ratio \hat{γ}.

This differentiable mathematical function may, for example, be the EESM function, which contains two calibration parameters c=[c₁, c₂] such that:

$$f ( c , S ) = - {c}_{2} log \frac{1}{N} {\sum }_{i = 1}^{N} {e}^{\frac{- {S}_{i}}{{c}_{1}}}$$

It will be noted that any other differentiable SNR-compressing function may be used, such as for example a mutual-information-based function called MIESM function known from the document Latif et al.

In the case of OFDM (whatever the channel) or of per-level flat fading in the case of frequency hopping, the SNR vector S is determined on the basis of a step T of processing a channel attenuation vector h of the radio link.

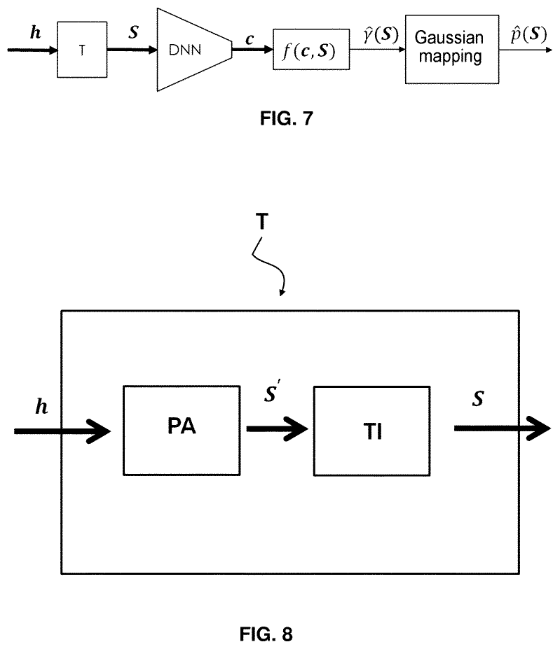

FIGS. 7 and 8 illustrate such a processing step T. Thus, this step T comprises a processing step (PA) in order to take into account a number of transmit antennas Nₜ≥1 and a number of receive antennas Nᵣ≥1, with a view to obtaining a signal-to-noise-ratio vector S′.

Thus, the channel attenuation vector h may be written:

$$h = [ vect ( {H}_{1} ) , vect ( {H}_{2} ) , … , vect ( {H}_{{N}_{d}} ) ]$$

with N_{d} the number of dimensions in which the effective SNR is evaluated, for example the number of OFDM sub-carriers or the number of frequency-hopping levels, Hᵢ a matrix (Nᵣ, Nₜ) of the attenuations of the channel for the dimension i in question (sub-carrier or level), and Hᵢ(k, l) the element (k, l) of the matrix Hᵢ.

In the case of a SISO mode (SISO standing for single-input single-output), i.e. when Nₜ=Nᵣ=1, the following relationships are obtained:

$$h = [ {H}_{1} ( 1 , 1 ) , {H}_{2} ( 1 , 1 ) , … , {H}_{{N}_{d}} ( 1 , 1 ) ]$$

$${S}_{i}^{′} = {\vert {h}_{i} \vert}^{2} \frac{{P}_{Tx}}{{σ}_{b}^{2}}$$

with hᵢ the ith element of the vector h.

In the case of a SIMO mode (SIMO standing for single-input multiple-output), where Nₜ>1 and Nᵣ=1, the following relationships are obtained, for example for Nₜ=2:

$$h = [ {H}_{1} ( 1 , 1 ) , {H}_{1} ( 2 , 1 ) , {H}_{2} ( 1 , 1 ) , {H}_{2} ( 2 , 1 ) , … , {H}_{{N}_{d}} ( 1 , 1 ) , {H}_{{N}_{d}} ( 2 , 1 ) ]$$

In an option 1, in which there is no information on the receiver:

$${S}_{i}^{′} = {\vert {h}_{i} \vert}^{2} \frac{{P}_{Tx}}{{σ}_{b}^{2}}$$

with hᵢ the ith element of the vector h.

In an option 2, in which the receiver is known, the receiver for example being an MRC receiver (MRC standing for maximum ratio combining):

$${S}_{i}^{′} = ( {\vert {H}_{i} ( 1 , 1 ) \vert}^{2} + {\vert {H}_{i} ( 2 , 1 ) \vert}^{2} ) \frac{{P}_{Tx}}{{σ}_{b}^{2}}$$

In the case of a MIMO mode (MIMO standing for multiple-input multiple output), where Nₜ>1 and Nᵣ>1, the following is obtained:

$$h = [ {H}_{1} ( 1 , 1 ) , {H}_{1} ( 1 , 2 ) , … , {H}_{1} ( 1 , {N}_{t} ) , {H}_{1} ( 2 , 1 ) , \text{} … , {H}_{1} ( 2 , {N}_{t} ) , … , {H}_{1} ( {N}_{r} , 1 ) , … , {H}_{1} ( {N}_{r} , {N}_{t} ) , {H}_{2} ( 1 , 1 ) , {H}_{2} ( 1 , 2 ) , \text{} … , {H}_{2} ( 1 , {N}_{t} ) , {H}_{2} ( 2 , 1 ) , … , {H}_{2} ( 2 , {N}_{t} ) , … , {H}_{2} ( {N}_{r} , 1 ) , \text{} … , \text{} {H}_{2} ( {N}_{r} , {N}_{t} ) , {H}_{{N}_{d}} ( 1 , 1 ) , {H}_{{N}_{d}} ( 1 , 2 ) , … , {H}_{{N}_{d}} ( 1 , {N}_{t} ) , {H}_{{N}_{d}} ( 2 , 1 ) , \text{} … , {H}_{{N}_{d}} ( 2 , {N}_{t} ) , … , {H}_{{N}_{d}} ( {N}_{r} , 1 ) , … , {H}_{{N}_{d}} ( {N}_{r} , {N}_{t} ) ]$$

In an option 1, in which there is no information on the receiver:

$${S}_{i}^{′} = {\vert {h}_{i} \vert}^{2} \frac{{P}_{Tx}}{{σ}_{b}^{2}}$$

with hᵢ the ith element of the vector h. [00074]

In an option 2, in which the receiver is optimal:

$${S}_{i}^{′} = {λ}_{i} {P}_{Tx} / {σ}_{b}^{2}$$

with λᵢ the highest value of Hᵢ.

In the particular case of channels in which frequency-selective fading acts on each frequency-hopping level, the components of the vector h are no longer scalars but vectors of the impulse responses of said channels. In this case, the receiver performs an equalization on each of the levels and the elements

$${S}_{i}^{′}$$

of the vector S′ are then equal to the post-equalization SNRs of the component hᵢ, which are calculated or measured depending on the application.

In FIG. 8, the signal-to-noise ratio S′ is processed in the course of a step TI of processing of invariance by permutation of said signal-to-noise-ratio vector S′, to obtain the SNR vector S. This processing step TI makes it possible to take into account invariance by permutation of the input SNR vector. Specifically, the quality of the link does not depend on the order of the SNR values in the vector, i.e. p(S)=p(σ(S)) regardless of the permutation o ( ) Furthermore, this processing step TI makes it possible to mitigate a relatively small size of the learning database BD (a few thousand representations).

In one particular embodiment, this processing step TI is a sorting step in which:

$${S}^{′} = [ {S}_{1}^{′} , {S}_{2}^{′} , … , {S}_{N}^{′} ]$$

the components of which are ordered in the order of the vectorization operations of the matrices Hᵢ or in the order of the processing performed with knowledge of the receiver,
and

$$S = [ {S}_{{k}_{1}}^{′} , {S}_{{k}_{2}}^{′} , … , {S}_{{k}_{N}}^{′} ]$$

which respect the order relationship

$${S}_{{k}_{1}}^{′} \geq {S}_{{k}_{2}}^{′} \geq … \geq {S}_{{k}_{N}}^{′}$$

with kᵢ≠kⱼ for i≠j and the set {kᵢ, i=1, . . . , N}∈{1, . . . , N}.

Such a step of sorting the input data, in this case by increasing order, is simple to implement. It makes it possible to obtain good inference results with a frugal learning database BD.

In one particular embodiment, the processing step TI is a discretization in which S is a vector of dimension (P+1)>N.

The following equation is obtained:

$$x = {\sum }_{i = 1}^{N} {d}_{i}$$

where dᵢ for i∈{1, . . . , N} is determined according to the following equations:

P real values {vₖ, k=1, . . . , P} respecting v₁≤v₂≤ . . . ≤vₚ are defined.

$$For k = 2 , … , P , {d}_{i} ( k ) = 1 if ( {v}_{k} - 1 ) \leq {S}_{i}^{′} < {v}_{k} , otherwise {d}_{i} ( k ) = 0$$

$${d}_{i} ( 1 ) = 1 if {S}_{i}^{′} < {v}_{1} , otherwise {d}_{i} ( 1 ) = 0.$$

$${d}_{i} ( P + 1 ) = 1 if {S}_{i}^{′} > {v}_{1} , otherwise {d}_{i} ( P + 1 ) = 0 .$$

In a first option, S=min (x, 1), therefore there are N elements equal to 1 and (P−N) elements equal to 0.

In a second option, S=x, therefore there are n≤N non-zero elements and (P−n) elements equal to 0.

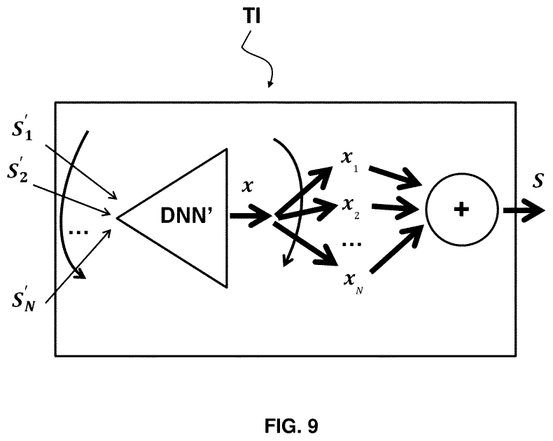

In one embodiment illustrated in FIG. 9, the processing of invariance by permutation TI is an operation performed by deep neural networks called DeepSet. This processing consists in processing the vector

$${S}^{′} = [ {S}_{1}^{′} , {S}_{2}^{′} , … , {S}_{N}^{′} ]$$

by means of an architecture of deep neural networks DNN′ that delivers as output a set of vectors {x₁, x₂, . . . , x_{N}} the components of which are added term by term to form the SNR vector S. The scalar inputs

$${S}_{k}^{′}$$

produce the vector outputs xₖ for k=1, . . . , N, through the same architecture of deep neural networks DNN′ implementing the same weights.

The invention thus allows:
introduction a mathematical model associated with the DNN architecture with a view to predicting performance of radio links in terms of packet error rate and the associated architecture;
introduction of the mathematical model makes it possible to obtain much higher accuracy because the DNN learns as many vectors c as there are input vectors S in the learning database, whereas in conventional methods a single vector c is determined for the entire database. It is thus possible to show that, for certain mathematical models, there are two-dimensional and one-dimensional vectors c that make it possible to predict exactly (i.e. without error) the effective SNR for any input vector S;
an accurate inferred prediction of the performance of the radio links;
a good performance to be obtained even with a frugal database.

The invention more particularly relates to operators and manufacturers of wireless communication systems.

The method for predicting the predicted packet error rate p may advantageously be implemented in a transmitting base station of a wireless communication network.

1. A method for predicting a predicted packet error rate (\hat{p}) of a radio link (L_{R}) between a transmitter and a receiver in a wireless communication network for a plurality of modulation coding schemes (MCS), said predicting method comprising:
a step of receiving an SNR vector(S);
a step of determining a vector (c) of calibration parameters on the basis of said received SNR vector(S), said step of determining the vector (c) of calibration parameters being carried out on the basis of an architecture of deep neural networks (DNN);
a step of processing said calibration parameters determined for the received SNR vector (S), by means of a differentiable mathematical function (ƒ(c, S)), with a view to obtaining the predicted effective signal-to-noise ratio (\hat{γ});
a step of Gaussian mapping making it possible to determine the predicted packet error rate (\hat{p}) on the basis of the predicted effective signal-to-noise ratio (\hat{γ}).

2. The predicting method as claimed in claim 1, wherein the Gaussian mapping is performed by piecewise interpolation and in that said predicting method comprises:
a step of learning weights of the deep neural networks (DNN) on the basis of pairs containing an SNR vector(S) and an associated effective signal-to-noise ratio (γ), said pairs (S, γ) being determined for the plurality of modulation coding schemes (MCS), said pairs (S, γ) being stored beforehand in a learning database (BD), the effective signal-to-noise ratios (γ) of the pairs (S, γ) being determined via an inversion of the Gaussian mapping, said Gaussian mapping being obtained via simulation of a Gaussian channel for a given modulation coding scheme.

3. The predicting method as claimed in claim 1, wherein the Gaussian mapping is performed by global interpolation and in that said predicting method comprises:
a step of learning weights of the deep neural networks (DNN) on the basis of pairs containing an SNR vector(S) and an associated packet error rate (p), said pairs (S, p) being determined for the plurality of modulation coding schemes (MCS), said pairs (S, p) being stored beforehand in a learning database (BD).

4. The predicting method as claimed in claim 1, wherein the SNR vector(S) is determined on the basis of a step (T) of processing a channel attenuation vector (h) of the radio link (L_{R}).

5. The predicting method as claimed in claim 4, wherein the step (T) of processing the channel attenuation vector (h) comprises a processing step (PA) making it possible to take into account a number of transmit antennas (Nₜ), the transmitter having a plurality of antennas, and a number of receive antennas (Nᵣ), the receiver having a plurality of antennas, with a view to obtaining a signal-to-noise-ratio vector (S′).

6. The predicting method as claimed in claim 5, wherein the step (T) of processing the channel attenuation vector (h) comprises a step (TI) of processing of invariance by permutation of the signal-to-noise-ratio vector (S′) to obtain the SNR vector (S).

7. The predicting method as claimed in claim 6, wherein the processing of invariance by permutation (TI) is a sorting operation.

8. The predicting method as claimed in claim 6, wherein the processing of invariance by permutation (TI) is a discretization operation.

9. The predicting method as claimed in claim 6, wherein the processing of invariance by permutation (TI) is performed by other deep neural networks (DNN′).

10. The predicting method as claimed in claim 1, wherein the SNR vector(S) is concatenated with an average signal-to-noise ratio (S̅N̅R̅).

11. The predicting method as claimed in claim 1, wherein the SNR vector(S) is concatenated with a vector (o) encoding one 1 among M zeroes, in the case of M modulation coding schemes (MCS).

12. The predicting method as claimed in claim 1, wherein the differentiable mathematical function (ƒ(c, S)) corresponds to the following equation:
$$f ( c , S ) = - {c}_{2} log \frac{1}{N} {{\sum }^{N}}_{i = 1} {e}^{\frac{- {S}_{i}}{{c}_{1}}}$$
with c₁ a first calibration parameter and c₂ a second calibration parameter, Sᵢ the ith value of the SNR vector(S), i ranging from 1 to N and N denoting the number of SNR vectors(S).

13. The predicting method as claimed in claim 12, wherein the first calibration parameter c₁ is equal to 1 and said differentiable mathematical function (ƒ(c, S)) corresponds to the following equation:
$$f ( c , S ) = - {c}_{2} log \frac{1}{N} {\sum }_{i = 1}^{N} {e}^{- {S}_{i}}$$

14. The predicting method as claimed in claim 12, wherein the second calibration parameter c₂ is equal to 1 and said differentiable mathematical function (ƒ(c, S)) corresponds to the following equation:
$$f ( c , S ) = - log \frac{1}{N} {\sum }_{i = 1}^{N} {e}^{\frac{- {S}_{i}}{{c}_{1}}}$$
